(19) United States
(12) Patent Application Publication
(10) Pub. No.: US 2006/0060687 A1
(43) Pub. Date: Mar. 23, 2006

(54) Fishing reel having externally controlled spool brake

(75) Inventor: Kwang-Hee Lee, Incheon-Shi (KR)

Correspondence Address: Peter T. Kwon;G W i P S, Kangnam P.O. Box 2301, Seoul, 135-242, KR

(73) Assignee: Seoul Fishing Reel Inc.

(21) Appl. No.: 11/136,507

(22) Filed: May 25, 2005

(30) Foreign Application Priority Data
Sep. 23, 2004 (KR) 2004-0027372

(51) Int. Cl. A01K 89/02

(52) U.S. Cl. 242/289

(57) ABSTRACT

An externally controlled device for braking a spool of a baitcast fishing reel is provided for dramatically extending the casting distance. This device comprises a brake frame, a movable housing, a control knob, a brake ring, a rotator housing, a plurality of L-shaped brake pads with different lengths, a fixing cover, and a retaining ring. A braking force is controlled according to a stepwise rotation of the control knob for adjusting a clearance between a movable housing and the brake ring, The brake pad elastically supported by the coil spring is pushed outward against the resilient force of coil spring by a centrifugal force at the high speed rotation of spool. When the rotating speed of the spool falls below a certain level, the brake pads are separated from the brake ring for free-rotation of the spool.

### BACKGROUND OF THE INVENTION

1. Field of the Invention

The present invention relates to a baitcast reel for fishing, and more particularly to an externally-controlled device for braking the speed of a spool of a baitcast reel, which facilitates control of a rotating speed of the spool when bait is cast, and significantly extends the casting distance by automatically removing a braking force from the spool below a certain rotational speed so that the time for free rotation is extended.

2. Related Prior Art

A baitcast reel has a function of hanging various kinds of fishhooks and baits at the end of a fishing line wound around a spool and then casting them to a desired position. The baitcast reel is generally used for casting the fishhook and the bait a long distance, though the distance depends on the casting power, so that the spool rotates at a high speed (about 1500 rpm) when discharging a line. The spool starts rotating by means of the casting force exerted on the weight of the bait and tackle when the cast is initiated. After the bait reaches the top of its trajectory, the spool should begin to discharge the line at a significantly reduced speed. However, the inertia of the spool causes the spool to continue to rotate rapidly, which results in excessive unreeling of the line, thereby causing the fishing line to become rapidly tangled inside the reel.

Thus, a baitcast reel in which a line is unreeled by means of the rotation of a spool employs a well-known structure as shown in FIG. 6 in order to apply a braking force to the rotation of the spool. However, in order to adjust the amount of braking force to be applied, a spool assembly having brake shoes must be dissembled and then a plurality of brake shoes must be adjusted individually to suitable operating positions. In addition, since the brake shoes are always in contact with the inner circumference of a brake ring to apply a braking force to the spool while the spool is rotating, the casting distance is shortened.

That is to say, the braking device of a spool used for the baitcast reel as mentioned above is configured as shown in FIG. 5. A plurality of brake pins 103 are fixed in a radial direction to the circumference of a brake housing 102 fitted into the outer circumference of a spool shaft 101 adhered to the inside of a spool 100 so as to cause sliding movement of the brake shoes 104. A centrifugal force generated by rotation of the spool 100 forces the brake shoes 104 to be sprung outward, and this springing force on the brake shoes 104 causes friction between an end 105 of the brake shoe 104 and an inner side of the brake ring 106, thereby reducing the rotating speed of the spool 100.

In fact, since baits of various kinds, sizes and shapes are used for fishing depending on what type of fish the angler wishes to attract, the strength of the frictional resistance should be controlled in some situations. However, to achieve this control, the conventional well-known spool braking device requires tedious maintenance in which the spool assembly is disassembled and separated and then flanges of the brake shoes should be individually adjusted to be positioned in or out of a stop boss of the brake housing.

In addition, during this work, the brake shoes may be lost or broken. Moreover, since much time is required for the disassembly, adjustment and reassembly, the conventional reel is very inefficient to adjust during fishing. Furthermore, since the rotating speed of the spool is continuously reduced due to the decreased inertia and the centrifugal force applied to the brake shoes at the end of casting, the casting distance is shortened by a conventional baitcast reel.

### SUMMARY OF THE INVENTION

The present invention is designed to solve the problems of the prior art, and therefore an object of the invention is to provide an externally-controlled device for braking a spool of a baitcast reel for fishing, which dramatically extends the casting distance by allowing the braking force for controlling rotation of the spool to be adjusted by rotating a control knob through multiple stages, thus adjusting the braking force without disassembling a spool assembly from a reel body, and by permitting the brake pad and a brake ring to be separated so that the spool may freely rotate when the rotational speed of the spool is below a certain level, to lessen the centrifugal force exerted on the brake pad, thereby extending the casting distance.

In accordance with the present invention, there is provided an externally controlled device for braking a spool of a baitcast reel for fishing, in which the spool is combined with a spool shaft and a braking means provided on one side of an inner portion of the spool, wherein a brake frame including a movable housing is inserted into a side cover, and a control knob having a stepped boss is inserted therein from an outer side of the side cover so that the stepped boss is engaged with a terraced protrusion formed on one side of the movable housing, wherein a spring boss is formed to protrude from one side of the brake frame, and an inclined spring is elastically installed to the spring boss so that the movable housing is elastically supported from an inner side of the brake frame by means of the inclined spring, wherein a brake ring having a sloped surface on its inner circumference is fitted and fixed in the movable housing, and a rotator housing in which L-shaped brake pads of different lengths are elastically inserted in a radial direction by coil springs is affixed to one side of the spool, wherein a fixing cover from which a front end of the brake pad protrudes is combined with an outer circumference of the rotator housing, wherein a retaining ring is inserted into the center of the rotator housing and the fixing cover so that a lower end of the brake pad contacts the retaining ring and is fixed by means of an upward elastic force of the coil spring, and wherein, when the control knob is rotated stepwise, a centrifugal force caused by rotation of the spool according to the motion of the movable housing and the brake ring therein causes the brake pad to protrude and contact an inner surface of the brake ring, thereby applying a braking force acting against the rotation of the spool.

### BRIEF DESCRIPTION OF THE DRAWINGS

Other objects and aspects of the present invention will become apparent from the following description of embodiments with reference to the accompanying drawings in which:

FIG. 1 is an exploded perspective view showing a device for braking a spool of a baitcast reel according to one embodiment of the present invention;

FIG. 2 is an exploded perspective view showing a device for braking a spool of a baitcast reel according to another embodiment of the present invention;

FIG. 3 is a cutaway view showing the outward appearance of the baitcast reel and the internal arrangement of a spool braking unit;

FIGS. 4a to 4e show operation states of the spool braking device according to the present invention in each stage, wherein:

FIG. 4a is a sectional view showing a braking unit in the state that a centrifugal force is not applied to the spool;

FIG. 4b is a sectional view showing the braking unit in the state that a centrifugal force is applied to the spool with a control knob set to “0” position;

FIG. 4c is a sectional view showing the braking unit in the state that a centrifugal force is applied to the spool with a control knob set to “2” position;

FIG. 4d is a sectional view showing the braking unit in the state that a centrifugal force is applied to the spool with a control knob set to “4” position;

FIG. 4e is a sectional view showing the braking unit in the state that a centrifugal force is applied to the spool with a control knob set to “6” position;

FIG. 5 is a graph comparing the casting distance according to the present invention; and

FIG. 6 is a sectional view showing a conventional braking unit of a baitcast reel.

### DETAILED DESCRIPTION OF THE INVENTION

Hereinafter, a preferred embodiment of the present invention is described.

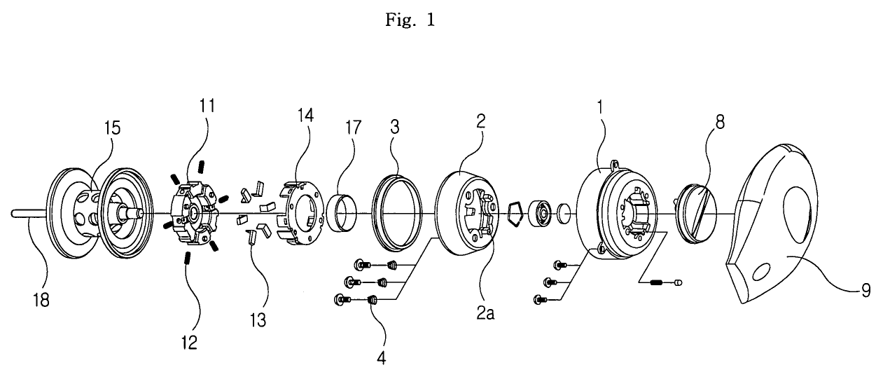

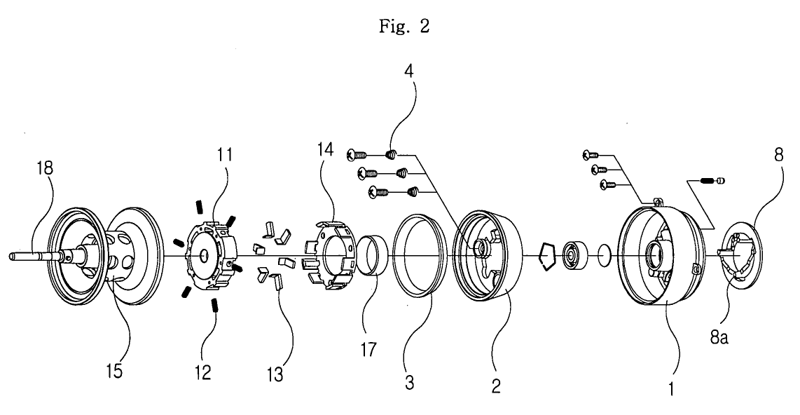

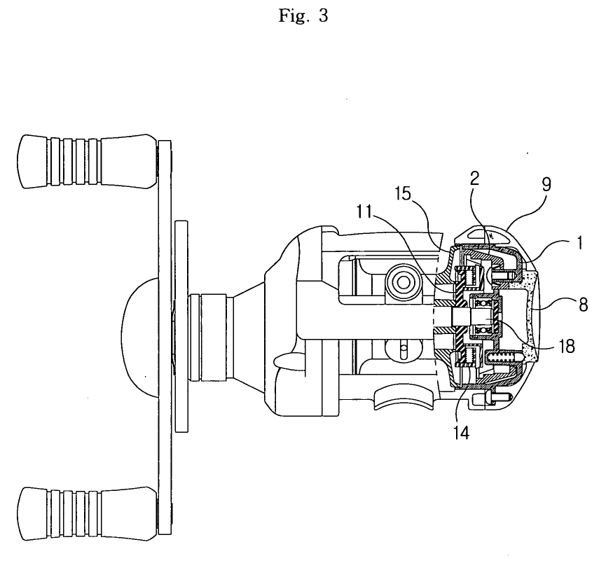

FIG. 1 is an exploded perspective view showing a device for braking a spool of a baitcast reel according to one embodiment of the present invention, FIG. 2 is an exploded perspective view showing a device for braking a spool of a baitcast reel according to another embodiment of the present invention, and FIG. 3 is a cutaway view showing the outward appearance of the baitcast reel and the internal arrangement of a spool braking unit.

An externally controlled device for braking a spool of a baitcast reel for fishing is configured so that the spool is combined to a spool shaft and a braking means is provided on one side of an inner portion of the spool.

A brake frame 1 including a movable housing 2 is inserted into a side cover 9, and a control knob 8 having a stepped boss 8a is inserted therein from the outside of the side cover 9 so that the stepped boss 8a is engaged with a terraced protrusion 2a formed on one side of the movable housing 2.

A spring boss 1a is formed to protrude from one side of the brake frame 1, and an inclined spring 4 is elastically installed to the spring boss 1a so that the movable housing 2 is elastically supported by means of the inclined spring 4.

A brake ring 3 having a sloped surface on an inner circumference is fitted and fixed in the movable housing 2, and a rotator housing 11 in which L-shaped brake pads 13 of different lengths are elastically inserted in a radial direction by coil springs 12 is affixed to one side of the spool 15.

A fixing cover 14 from which a front end of the brake pad 13 protrudes is combined with an outer circumference of the rotator housing 11.

A retaining ring 17 is inserted in a center of the rotator housing 11 and the fixing cover 14 so that a lower end of the brake pad 13 contacts the retaining ring 17 and is fixed by means of an upward elastic force of the coil spring 12.

When the control knob 8 is rotated stepwise, a centrifugal force caused by rotation of the spool 15 according to the motion of the movable housing 2 and the brake ring 3 therein causes the brake pad 13 to protrude and contact an inner surface of the brake ring 3, thereby applying a braking force acting against the rotation of the spool 15.

In addition, three groups, each group having two diametrically opposed brake pads 13.

Each group of the brake pads 13 have different heights so that the number of brake pads contacting the brake ring 3 varies when the brake pad 13 is protruded by a rotational centrifugal force of the spool 15, by means of the different gaps between each brake pad 13 and the inner side of the brake ring 3 according to the position change of the movable housing 2. Accordingly, the braking force of the device may be variously controlled by means of the control knob 8 depending on the weight of bait and tackle being used.

In particular, the brake pad 13 elastically supported by the coil spring 12 is pushed outward against the force of the coil spring 12 by a centrifugal force when the spool 15 rotates at high speed, thereby generating a braking force by means of interference with the brake ring 3. Conversely, when the spool 15 rotates at low speed, the brake pad 13 is not extended due to the restoring force of the coil spring 12, so that the spool 15 can rotate freely. Accordingly, when bait is cast, the distance of the cast may be significantly extended.

In addition, by using the same principle as the stepwise spool braking structure, it is possible for the brake pads 13 to be of equal length while an inner side of the brake ring 3 is eccentrically tapered. In this case, when a spool braking force is controlled by means of the control knob 8, the contact area between the inner side of the brake ring 3 and the brake pads 13 protruded by the same length by a centrifugal force according to each control stage may be increased or decreased in a stepwise manner, thereby providing the same effect as illustrated above.

The operation of the externally controlled device for braking a spool of a baitcast fishing reel according to the present invention will now be described in more detail.

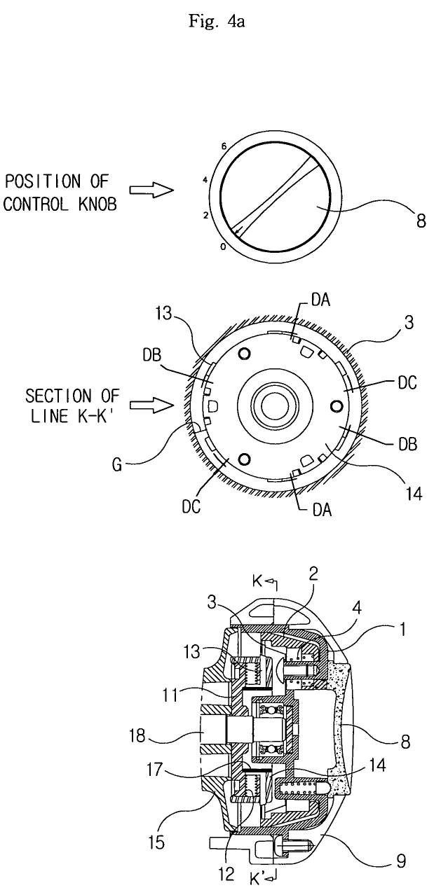

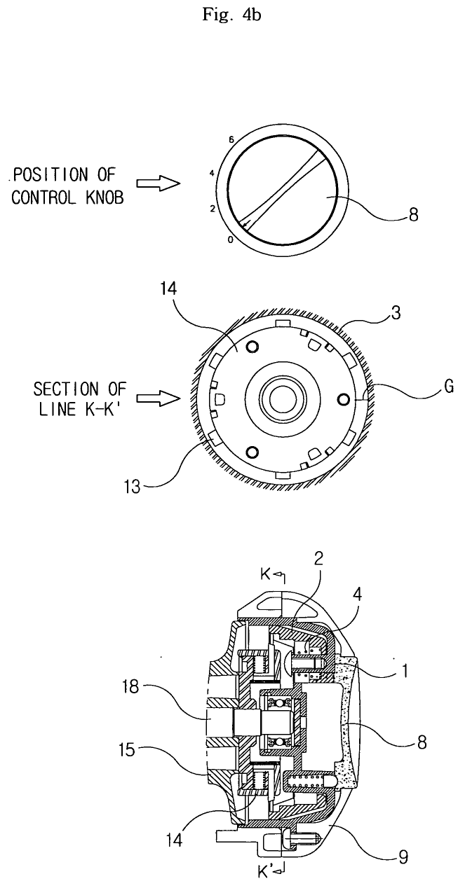

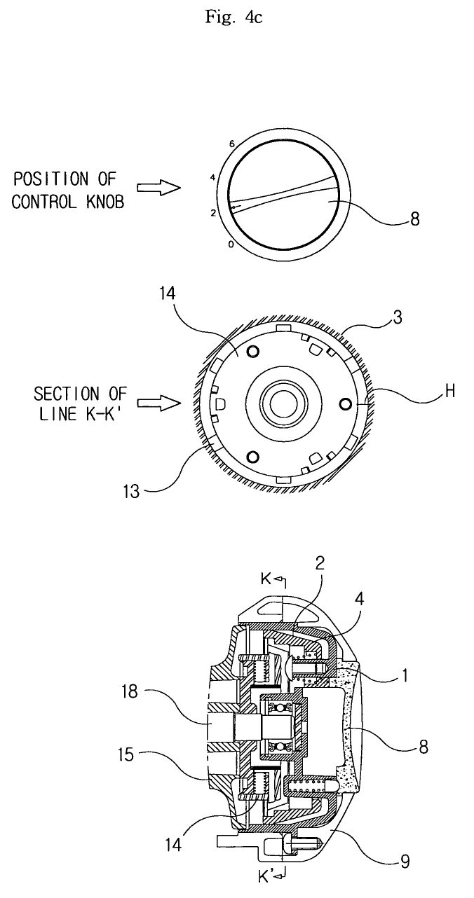

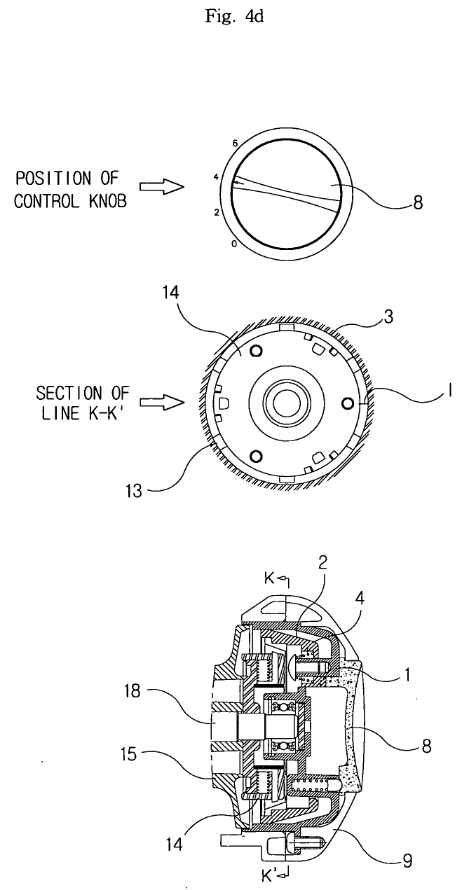

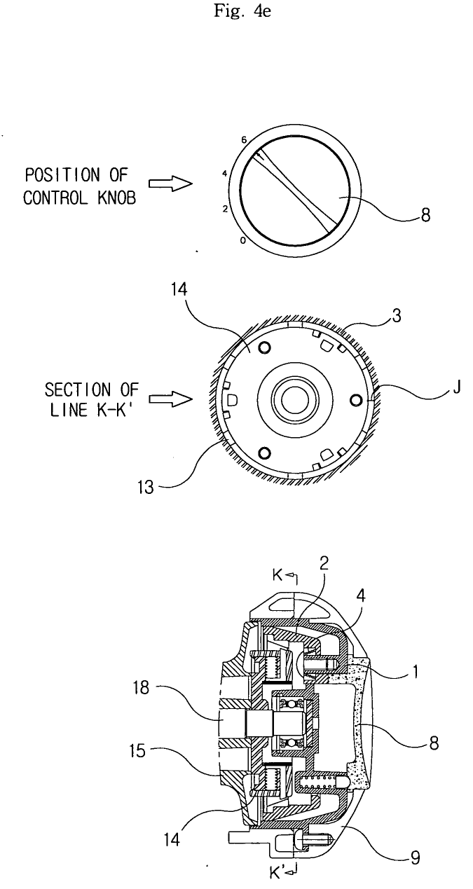

As shown in FIG. 4a, the rotator housing 11 is fitted and fixed into the outer circumference of a spool shaft 18 affixed to the spool 15. Then, after coil springs 12 are assembled to six hollows of the rotator housing 11, the brake pads 13 are inserted into a concave portion of the upper portion thereof. Then, a separate fixing cover 14 is assembled thereto, and the retaining ring 17 is fitted and fixed into the inner circumference of the rotator housing 11.

In this case, the brake pad 13 stops at a point of contact with the outer circumference of the retaining ring 17 by means of the restoring force of the coil springs 12.

That is to say, distances DA, DB and DC of the front end of the brake pad 13, extending from the concave portion of the rotator housing 11, are minimized.

In addition, the brake pads 13 installed in a radial direction are symmetrically positioned every 60° with different lengths along the center of the axis of the spool 15.

FIG. 4a shows that the spool is not rotating and the control knob 8 is set to “0” for a spool braking force. In this state, a lowermost end of the stepped boss 8a of the control knob 8 contacts the protruded boss 2a of the movable housing 2. At this time, due to the resilient force of the inclined spring 4 assembled to the spring boss 1a protruding into the brake frame 1, the brake ring 3 adhered to the movable housing 2, or a portion thereof, is moved to an initial point, or one side of the side cover 9. Thus, a gap G between the outer circumference of the rotator housing 11 and the brake ring 3 having a sloped surface is maximized.

As shown in FIG. 4b, though the spool 15 rotates at a high speed so that front ends of the brake pads 13 are pushed outward by a centrifugal force which exceeds the restoring force of the coil springs 12, the brake pads 13 do not generate friction with the brake ring 3, owing to the gap between the brake ring 3 and the spool 15, and thus the spool may rotate freely without coming under the influence of any frictional force.

Since the inner circumference of the brake ring 3 is inclined in a trapezoidal shape, the gap G is expanded due to right and left movement of the brake ring 3, caused by the steps of the stepped boss 8a of the control knob 8. Thus, the reel may be smaller and lighter, and, if the control knob 8 is manipulated, a rotating angle of the control knob 8 may be smaller, thereby being capable of reducing the time required for changing the setting.

Since the brake pads 13 installed on the same plane of the rotator housing 11 in a radial direction are mostly depressed in concave grooves of the rotator housing 11, it is possible to solve a conventional problem that the spool is influenced by air resistance even in a free state due to the pinwheel effects of a brake pin or a brake shoe of a conventional spool braking device.

That is to say, in conventional cases, the rotation of the spool is stopped within a relatively short time due to air resistance though the spool is set to a position “0” where the spool freely rotates.

FIG. 4c shows that the control knob 8 is rotated one click to indicator point “2”. In this state, a boss of the stepped boss 8a of the control knob 8 at a second-stage height pushes the movable housing 2 leftward. Thus, a gap H between the brake ring 3 and the rotator housing 11 is decreased in comparison with the gap G by one step, so that the ends of the two longest brake pads among the six brake pads 13 come into contact with the inner side of the brake ring 3 and then cause friction while rotating. At this time, it can be said that the two brake pads 13 pushed outward by centrifugal force while the spool 15 rotates at a high speed apply frictional resistance at a first-stage level.

In addition, if the control knob 8 is rotated by one click and one further click so that the indicator point is positioned to “4” and “6” respectively as shown in FIGS. 4d and 4e, bosses of the stepped boss 8a of the control knob 8 at second- and third-stage heights push the movable housing 2 leftward respectively. Thus, a gap I or a gap J between the brake ring 3 and the rotator housing 11 is decreased in comparison with the gap H or the gap I by one step, so that four brake pads among the six brake pads 13, namely the two longest brake pads and another two shorter brake pads having a predetermined length, are protruded, or all six of the brake pads 13 having different lengths are protruded so that their ends contact the inner side of the brake ring 3 and then cause friction while rotating. At this time, it can be said that the protruded brake pads 13 apply frictional resistance at a second-stage level or a third-stage level corresponding to maximum resistance.

Due to such a structural principle, the braking force on the spool may be controlled in multiple stages by means of rotation of the control knob 8 in an easy way without disassembling the spool assembly from the reel body.

The examples shown in the drawings show the change of position of the brake pads 13 for each indicator point of the control knob 8. Except for FIG. 4a, all drawings correspond to the case in which a centrifugal force generated by high-speed rotation of the spool exceeds the restoring force of the coil spring 12.

If the spool rotates at a low speed so that a relatively weak centrifugal force is applied to the brake pads 13, the restoring force of the coil spring 12 pushes the brake pads 13 inward to separate the brake pads from the inner surface of the brake ring 3. Then, the spool assembly may rotate freely, thereby significantly extending the casting distance.

That is to say, a resistance set by high-speed rotation of the spool caused by a strong casting force exerted when bait is cast restrains free rotation of the spool 15, thereby preventing the fishing line from being unreeled unnecessarily. In addition to that, after the bait is cast over a certain distance, the rotating force of the spool 15 is decreased. However, since the frictional resistance becomes weaker from this point to allow free rotation of the spool, it is possible to obtain a greater casting distance than that obtained in conventional cases.

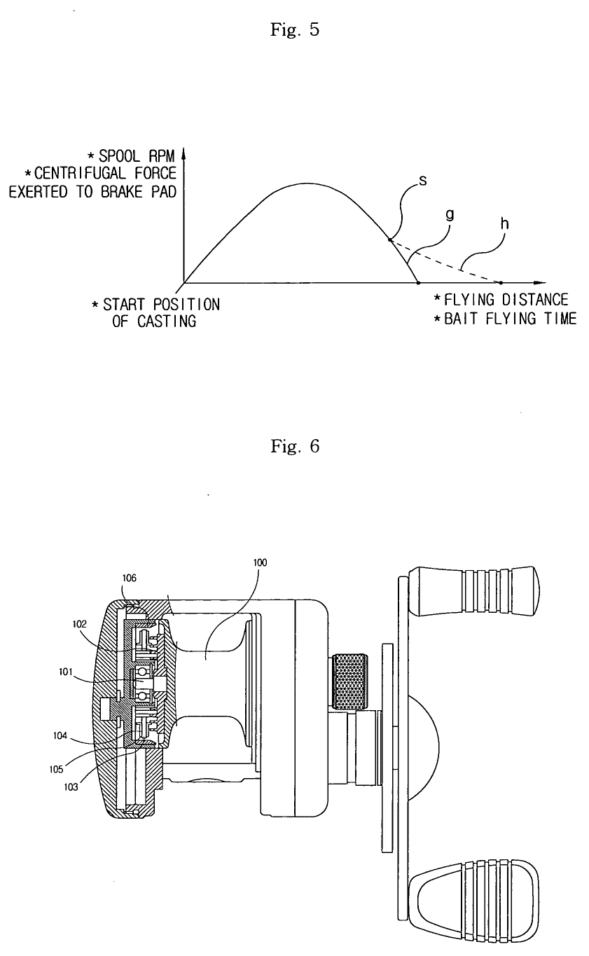

Thus, as shown in the graph of FIG. 5, illustrating the variation in flying distance, it is found that the trajectory of airborne bait (h) according to the present invention significantly increases the casting distance, compared with a trajectory (g) of a conventional baitcast reel.

In addition, these trajectories diverge from a point (s) where the restoring force of the coil spring 12 overcomes the centrifugal force which has decreased due to reduced rotation of the spool 15. From this point, the brake pads 13 do not influence the frictional resistance of the spool 15, such that free rotation of the spool 15 provides an extended flying distance. In addition, in the spool braking device of the present invention, the L-shaped brake pads 13 of different lengths are in contact with the inclined inner side of the brake ring 3, and this contact resistance varies the braking force.

As an identical principle, it is possible that the brake pads 13 are of equal length and an inner side of the brake ring 3 is eccentrically tapered. In this case, when a spool braking force is controlled by means of the control knob 8, the contact area between the inner side of the brake ring 3 and the brake pads 13 protruded by the same length due to a centrifugal force according to each stage control may be increased or decreased in a stepwise manner.

Thus, since the brake pads 13 having the same length are used to obtain such step-by-step braking forces as mentioned above, it is easier to manage parts, thereby improving ease of assembly and productivity of the baitcast reel.

Thus, the braking structure using the brake pads of different lengths and the inclined inner side of the brake ring and the braking structure using the brake pads of equal length and the eccentric inclined inner side of the brake ring are substantially based on the same technical spirit, included in the scope of the present invention.

The externally-controlled device for braking a spool of a baitcast fishing reel according to the present invention allows a significantly extended casting distance when bait is cast and also allows more effective casting since a braking force on the spool may be easily increased or decreased without disassembly depending the weight of the bait and tackle in use.

What is claimed is:

1. An externally controlled device for braking a spool of a baitcast fishing reel, in which the spool is mounted on a spool shaft and a braking means provided on one side of an inner portion of the spool, comprises:
a brake frame (1) including a movable housing (2) mounted inside of a side cover (9),
a control knob (8) having a stepped boss (8a) disposed outer side of said side cover (9), so that said stepped boss (8a) is engaged with a terraced protrusion (2a) formed on one side of the movable housing (2),
a spring boss protrusively formed from one side of the brake frame (1),
an inclined spring (4) installed to the spring boss, so that the movable housing (2) is elastically supported inner side of the brake frame (1) by resilient force of the inclined spring (4),
a brake ring (3) having a sloped surface on its inner circumference for fixedly mounting on the movable housing (2),
a rotator housing (11) having a plurality of inserting holes in radial directions, said rotator housing (11) attached to one side of the spool (15),
a plurality of L-shaped brake pads (13) with different lengths for inserting to said rotator housing (11) in a radial direction to elastically exert a braking force by coil springs (12),
a fixing cover (14) circumferentially mounted on said rotator housing (11) for retaining the plurality of brake pads (13), and
a retaining ring (17) being inserted between a center of the rotator housing (11) and the fixing cover (14), so that lower ends of the brake pads (13) are contacted to the retaining ring (17) by resilient force of coil springs (12).

2. The externally controlled device for braking a spool of a baitcast fishing reel according to claim 1, wherein said brake pads (13) inserted into the rotator housing (11) are divided into three groups of different protruded heights, each group has a pair of opposed brake pads (13) arranged in a radial direction for exerting braking force to the brake ring (3).

3. The externally controlled device for braking a spool of a baitcast fishing reel according to claim 2, said braking force is controlled according to a stepwise rotation of the control knob (8) for adjusting a clearance between said movable housing (2) and said brake ring (3), wherein the brake pads (13) are protruded to contact the inner surface of the brake ring (3) by a centrifugal force of the spool (15) for applying the braking force against the rotating spool (15).

4. The externally controlled device for braking a spool of a baitcast fishing reel according to claim 2, wherein the brake pad (13) elastically supported by the coil spring (12) is pushed outward against the resilient force of coil spring (12) by a centrifugal force at the high speed rotation of spool (15) for braking the brake ring (3), and at a low speed rotation of spool (15), the brake pads (13) are resumed back to original positions due to the restoring forces of the coil spring (12) for free-rotation of the spool (15).
